(19) United States
(12) Patent Application Publication
(10) Pub. No.: US 2017/0367274 A1
(43) Pub. Date: Dec. 28, 2017

(54) LIGHT AND HEAT MANAGEMENT SYSTEM FOR INDOOR HORTICULTURE

(71) Applicant: 3M INNOVATIVE PROPERTIES COMPANY, St. Paul, MN (US)

(72) Inventors: John A. WHEATLEY, Lake Elmo, MN (US); Guanglei DU, Woodbury, MN (US)

(21) Appl. No.: 15/540,954

(22) PCT Filed: Dec. 22, 2015
(86) PCT No.: PCT/US2015/067484

§ 371 Date: Jun. 29, 2017

Related U.S. Application Data
(60) Provisional application No. 62/097,964, filed on Dec. 30, 2014.

(51) Int. Cl. A01G 9/24; A01K 63/06; F21V 29/58; F21V 29/71; F21V 29/60; F21V 8/00; A01G 9/20; F21Y 2115/10

(52) U.S. Cl. CPC A01G 9/24; G02B 6/0096; A01K 63/065; A01G 9/20; F21V 29/58; F21V 29/717; F21V 29/60; F21Y 2115/10

(57) ABSTRACT

A system for heat and light management for indoor horticulture is described. More particularly, a system including light sources, a light distribution chamber, and circulating water is described.

### BACKGROUND

Indoor horticulture introduces challenges relating to heat management as compared to traditional, outdoor horticulture. Light sources are conventionally placed directly above the growing plants.

### SUMMARY

In one aspect, the present disclosure relates to a light and heat management system for indoor horticulture. In particular, the present disclosure relates to a system including a light distribution chamber having a first end and a second end, one or more light sources disposed proximate at least one of the ends of the light distribution chamber, and a fluid circulation system including a fluid, where at least one of the one or more light sources is thermally coupled to the fluid circulation system.

In some embodiments, the system further includes a heat exchanger, where the heat exchanger is thermally coupled to the fluid circulation system. In some embodiments, the fluid is water and the fluid circulation system further includes fish. In some embodiments, the fluid is a fluorochemical. In some embodiments, the fluid is a gas. In some embodiments, thermally coupled means heat is primarily transferred through conduction. In some embodiments, one or more of the fluid circulation system and the one or more light sources includes a heat sink. In some embodiments, the light distribution chamber is hollow. In some embodiments, the light distribution consists essentially of a multilayer optical reflector. In some embodiments, the light distribution consists essentially of a specular or semi-specular reflector. In some embodiments the light redistribution chamber consists essentially of a reflector and a light redirecting film. In some embodiments, the reflector is a multilayer optical reflector.

### BRIEF DESCRIPTION OF THE DRAWINGS

FIG. 1 is a schematic elevation cross-section of a conventional light and heat management system for indoor horticulture.

FIG. 2 is a schematic elevation cross-section of a light and heat management system for indoor horticulture.

### DETAILED DESCRIPTION

Indoor horticulture may provide better yields and all-season growing when compared with traditional horticulture. In addition, because the plants do not each necessarily require exposure to the sun, multilevel growing platforms may be utilized, where each level of plants has its own individual set of light sources. Of course, however, because the plants are grown indoors, the heat from the light sources, pumps, human attendants, and even respiration from plants themselves contribute to the ambient temperature and must be managed to maintain a desired or optimal growing temperature. In some cases, these horticulture systems are located in geographical locations having warm or hot climates, making heat removal and management particularly important.

The transition to light emitting diodes from, for example, incandescent bulbs or fluorescent lamps, has in many cases significantly reduced both power consumption and heat generation from the standpoint of light generation. Also, light emitting diodes may provide a much more idealized spectral power distribution based on, for example, the absorption of light by chlorophyll. However, the effectively point source sized LEDs can create headlamping effects, where light is not fully mixed before reaching the plants, especially where LEDs generating different wavelengths are used. Further, the spatially distributed heat generation of these arrays of LEDs makes cooling difficult and air cooling (i.e., convective circulation) is often used as the most practical solution. This requires large fans to circulate air within the room, potentially creating loud ambient noise levels which may be unpleasant or even dangerous to work in. Convective air cooling is typically less efficient than, for example, water cooling, because water has a higher specific heat (per unit mass) than air. However, water cooling, especially over an array of active electronics can be hazardous due to the risk of condensation or leaks causing a short circuit. Utilizing particular lighting modules may allow for a safer and more efficient heat management scheme while still providing additional light distribution benefits.

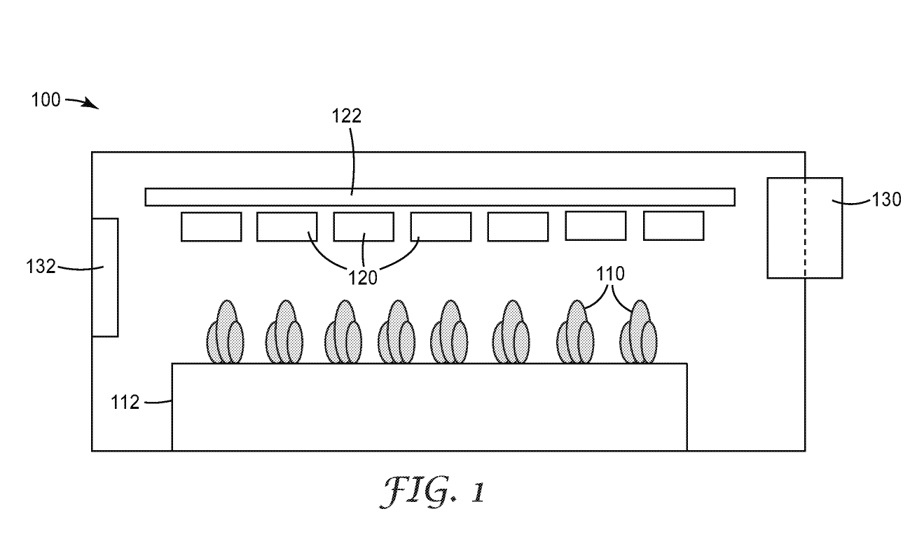

FIG. 1 is a schematic elevation cross-section of a conventional light and heat management system for indoor horticulture. Growing room 100 includes plants 110 disposed on platform 112 which may provide water and nutrients to the plants. Light sources 120 are suspended or otherwise attached from fixture 122. Heat exchanger 130 transfers heat out of growing room 100 and fan 132 aids in circulation of air through the room.

As described elsewhere, the light sources of fixture 122—along with all other heat sources within the conventional growing room depicted in FIG. 1—are air cooled, specifically by the general circulation of air in the room caused by a combination of fan 132 and heat exchanger 130. Heat exchanger 130 may sometimes also include a compressor or fan.

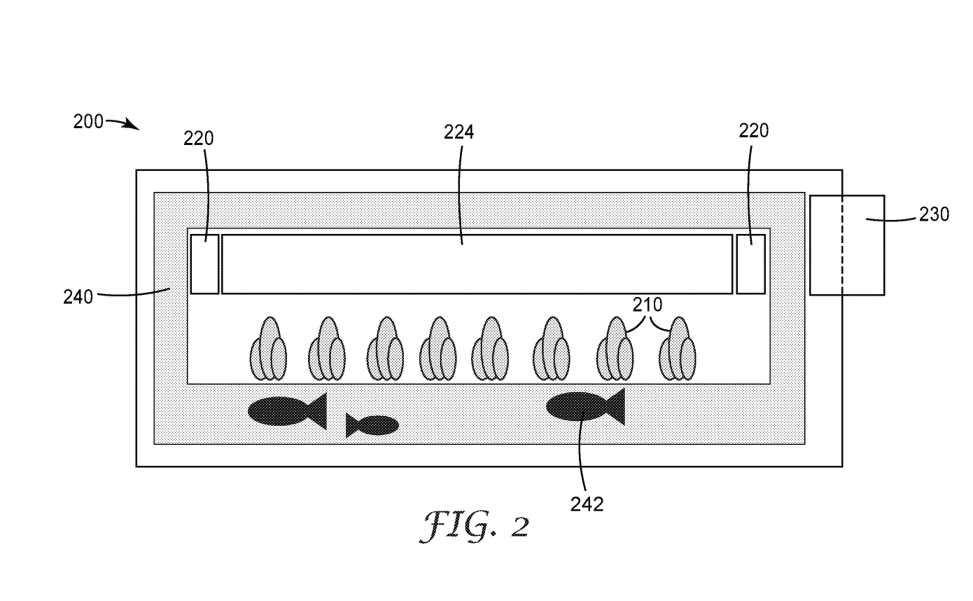

FIG. 2 is a schematic elevation cross-section of a light and heat management system for indoor horticulture. Growing room 200 includes plants 210. Light sources 220 inject light into light distribution chamber 224. Heat exchanger 230 is disposed partially within and partially without growing room 200. Water system 240 circulates water through growing room 200 and optionally includes fish 242.

Light sources 220 may be any suitable light source or combinations of light sources. In some embodiments, light sources 220 are LEDs. In some embodiments, light sources 220 include LEDs having different spectral power distributions. For example, light sources may emit visible wavelengths, ultraviolet wavelengths, near infrared wavelengths, or a combination thereof. In some embodiments, light sources 220 include suitable powering and driving electronics. In some embodiments, light sources 220 be selectively driven or controlled by a microprocessor. In some embodiments, light sources 220 may have controls to manipulate or adjust one or more optical properties of the light generated from the light sources (e.g., wavelength, spectral peaks or minima, luminance) automatically, semi-automatically (e.g., selecting a predetermined optical profile), or manually. Light sources 220 may include one or more sensors or clocks to either provide data about its status or to use as inputs for adjustments to its optical properties. In some embodiments, light sources 220 may simulate an optimal growing day or other period, regardless of the actual time, date, or location.

Light sources 220 may be, as depicted, on each side of the light distribution chamber, or, in some embodiments, light sources 220 may be only on one side of light distribution chamber 224. Light sources 220 may be designed to be an essentially monolithic modular structure, so that each unit of light sources 220 may be easily replaced if desired. Light sources 220 may also include suitable collimation or injection optics to provide a desired light distribution into light distribution chamber 224.

Light distribution chamber 224 provides light over an extended area. In some embodiments, light distribution chamber 224 is a solid lightguide. As a solid lightguide, light distribution chamber 224 may be formed from any suitable material, such as conventional acrylic, and may have any suitable shape and size. In some embodiments, light distribution chamber 224 may be a hollow lightguide with at least one of the major surfaces including a semi-specular reflective film or surface. Hollow lightguides, or more hollow recycling backlights, are described in more detail in, for example, U.S. Patent Publication No. 2012-0238686 A1 (Weber et al.). In some embodiments, the light distribution chamber includes a highly reflective film, such as Enhanced Specular Reflector (ESR) or Enhanced Diffuse Reflector (EDR), available from 3M Company, St. Paul, Minn. Using highly reflective films in transporting light may help maintain high efficiencies by minimizing wasted absorbed light. The reflective film may be formed in the shape of a tube, although any other suitable three-dimensional shape is possible, such as a box, a channel, or a duct having curved and/or rectilinear cross-sections. The reflective film may include one or more apertures and can even be perforated to transmit light in desired locations. The aperture may be simply open space (i.e., the lack of a reflective film) or it may include a light redirecting, collimating, or diffusing film, or a turning film, such as a prism film. The aperture or perforations may vary as a function of distance along the tube in order to provide even lighting. Radial variations are also possible. Embodiments including tubes of highly reflective films are described in the co-owned Provisional Patent No. 61/886,165, filed Oct. 3, 2013 and entitled “Remote Illumination System.” (Attorney Docket No. 74598US002). Using a sufficiently long tube as light distribution chamber 224 may help provide superior color mixing and provide a uniform distribution of light for plants 210. Additionally, the tube may have a mixing section near the light source.

Water 240 circulating within growing room 200 is thermally coupled to at least the light sources. In some embodiments, thermally coupled means that heat is primarily transferred through conduction. Light sources 220 may have an attached heat sink or just be sufficiently close to water 240 to thermally couple heat generated from the light sources to the water. Water 240 is pumped or circulated by any suitable mechanism, and may include other components, such as piping, a filter, or a heater. The system may collectively be called a fluid circulation system. Water 240 is also thermally coupled to heat exchanger 230 through, for example, proximity or an attached heat sink, so that heat is passed out of growing room 200. Thermal coupling may be through the floor of growing room 200, for example, through a concrete floor in intimate contact with the ground and therefore especially effective at dissipating heat. Note that while water 240 travels above light distribution chamber 224 and light sources 220, this is not necessarily in close proximity; for example, the water may be piped through the ceiling to minimize the possibility of direct dripping or leaks. Moreover, a greater area of the lighting system (light sources 220 along with light distribution system 224) does not include vulnerable electronics, compared to FIG. 1. In some embodiments, fish 242 or other aquaculture-appropriate species may be provided in water 240. Fish 242 may produce waste that fertilize plants 210 and may in some cases may be separately cultivated or farmed for food. In these embodiments, the plants should be at least partially disposed within (i.e., their roots should be partially within) water 240. In some embodiments, heat from light sources 220 may help water 240 stay at an appropriate temperature for fish 242. The type (salt vs. fresh) and specific properties of water 240 may depend on the desired fish.

In some embodiments, water 240 may not be water but may be some other liquid. Naturally, this would likely foreclose the opportunity for fish 242 to be present, and plants 210 would require a separate source of water. For example, water 240 may be a fluorochemical based fire suppression fluid, such as NOVEC brand Fire Protection Fluid, available from 3M Company, St. Paul, Minn. In some embodiments, water 240 may instead be a gas ducted through the fluid circulation system. In some embodiments, the gas is air.

Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

The following are exemplary embodiments according to the present disclosure:

Item 1. A light and heat management system for indoor horticulture, the system comprising:
a light distribution chamber having a first end and a second end;
one or more light sources disposed proximate at least one of the ends of the light distribution chamber;
a fluid circulation system including a fluid;
wherein at least one of the one or more light sources is thermally coupled to the fluid circulation system.

Item 2. The system of item 1, further comprising a heat exchanger, wherein the heat exchanger is thermally coupled to the fluid circulation system.

Item 3. The system of item 1, wherein the fluid is water.

Item 4. The system of item 3, wherein the fluid circulation system further includes fish.

Item 5. The system of item 1, wherein the fluid is a fluorochemical.

Item 6. The system of item 1, wherein the fluid is a gas.

Item 7. The system of item 1, wherein thermally coupled means heat is primarily transferred through conduction.

Item 8. The system of item 1, wherein one or more of the fluid circulation system and the one or more light sources includes a heat sink.

Item 9. The system of item 1, wherein the light distribution chamber is hollow.

Item 10. The system of item 1, wherein the light distribution chamber consists essentially of a multilayer optical reflector.

Item 11. The system of item 1, wherein the light distribution chamber consists essentially of a specular or semi-specular reflector.

Item 12. The system of item 1, wherein the light distribution chamber consists essentially of a reflector and a light redirecting film.

Item 13. The system of item 12, wherein the reflector is a multilayer optical reflector.

What is claimed is:

1. A light and heat management system for indoor horticulture, the system comprising:
a light distribution chamber having a first end and a second end;
one or more light sources disposed proximate at least one of the ends of the light distribution chamber;
a fluid circulation system including a fluid;
wherein at least one of the one or more light sources is thermally coupled to the fluid circulation system.

2. The system of claim 1, further comprising a heat exchanger, wherein the heat exchanger is thermally coupled to the fluid circulation system.

3. The system of claim 1, wherein the fluid is water.

4. The system of claim 1, wherein the fluid is a fluorochemical.

5. The system of claim 1, wherein the fluid is a gas.

6. The system of claim 1, wherein thermally coupled means heat is primarily transferred through conduction.

7. The system of claim 1, wherein the light distribution chamber is hollow.

8. The system of claim 1, wherein the light distribution chamber consists essentially of a multilayer optical reflector.

9. The system of claim 1, wherein the light distribution chamber consists essentially of a specular or semi-specular reflector.

10. The system of claim 1, wherein the light distribution chamber consists essentially of a reflector and a light redirecting film.
